(19) United States
(12) Patent Application Publication
(10) Pub. No.: US 2012/0239695 A1
(43) Pub. Date: Sep. 20, 2012

(54) DYNAMIC NUMERIC SEQUENCE MATCH

(75) Inventors: Jose Luis Merino Gonzalez, Malaga (ES); Jonathan Myers, Wokingham (GB)

(73) Assignee: Ghost Telecom Limited, Wokingham (GB)

(21) Appl. No.: 13/403,234

(22) Filed: Feb. 23, 2012

(30) Foreign Application Priority Data
Feb. 24, 2011 (GB) GB 1103135.8

(51) Int. Cl. G06F 17/30

(52) U.S. Cl. 707/780; 707/E17.014

(57) ABSTRACT

A system for determining dynamically any given input numeric sequence potential match against all available numeric sequences from a database, whereby the dynamic method reports the match or matches with the highest matching digits. The input numeric sequence(s) and the numeric sequences from databases can be of any length and therefore the input numeric sequence may be different in length to those numeric sequences from databases, yet the method will detect and report those database numeric sequences that provided the highest number of digits matching against any given input numeric sequence.

### CROSS-REFERENCE TO RELATED APPLICATIONS

This application is based on, and claims priority to GB Provisional Application No. GB 1103135.8, filed Feb. 24, 2011, the entire contents of which are hereby incorporated fully by reference.

### BACKGROUND

1. Field of the Invention

The present invention is directed to a service provided by a local telephone companies or service providers or database management for private or public use. Specifically, the service is designed to facilitate the information related to the most likely highest probability match for a particular numeric number sequence or telephone number.

2. Background of the Invention

Current systems and methods for identifying telephone user are cumbersome and inflexible. Generally, phone users who wish to make use of a specific 3rd party phone service or service provider service must request or search users they may know by name. Users of 3rd party services, different then the users own phone service from its own operator (be it fixed or mobile operator or service provider) need to do a considerable amount of effort to identify which of the 3rd party current or future users they already know and wish to have identified in their own existing database. Callers generally are not willing to conduct the considerable amount of research and investigation nor manual effort to find, select and add those users from a 3rd party service whom they already know, even more unlikely is that users will not re-do this previous exhaustive process manually over and over again in future to find, select and add to their own database more new users they know (without their knowledge) who also start to make use of such commonly used 3rd party service.

Recently, fixed line operators and service providers in particular have begun to offer on-line (internet) service allowing individuals to search on an individual name basis the phone number and other related data (i.e. user nickname, address or age, etc. if available) of such searched user. Fixed operators and in some cases mobile operators also provide in certain regions, a so called white pages (private users data) and/or yellow pages (business data) and/or personal assisted call centres where private or business individuals can ask verbally for the public details of a user in their database. This actually further complicates the simple task of a private or business individual who simple seeks to find out which of the people he knows (commonly stored in his own personal or business database) use the 3rd party service, meaning whom that he already knows is in the database of such 3rd party which a user wishes to make use of (i.e. 3rd party long distance call company database, service provider database, etc.).

Attempts have been made to ease the way to allow access by user to 3rd party user databases, however in a manual way thus none in an automated manner. Further Attempts have been made by companies providing automatic synchronization between 2 specific databases; however these two databases which can be synchronised must be accessible and owned by the same user, which in itself does not provide a solution to the issue described herein before.

### SUMMARY OF THE INVENTION

The present invention is designed to overcome the shortcomings of the prior art and to provide an automated way of identifying and reporting those numeric sequences (i.e. material parts numbers, parcels identification numbers, phone numbers in local or international format, IMSI, etc.) from a user database that match against such numeric sequence in a 3rd party database ((i.e. material parts numbers, parcels identification numbers, phone numbers in local or international format, IMSI, etc.), this last database not owned or managed by the user but rather by a 3rd party.

The present invention is preferably a service offered by materials parts or finished goods manufacturers and distributors of such material parts or finished goods or any such other parcel, a traditional telephone companies (fixed or mobile network operator), virtual network operators, service providers of phone book databases (white or yellow pages), telephony, text, video or VoIP service providers or any such company that wishes to allow their users to synchronize their own database with the company database (be it synchronizing or obtain products identification numbers or individuals data by phone number etc.). This is achieved by doing the reverse then is commonly used in the prior art namely; this invention relies on the user who wishes to synchronize his personal or business database to provide the data he wishes to synchronize or to allow the 3rd party company he wishes to synchronize his own database with, access to his own database by the 3rd party company. The 3rd party company will use the system or method of the present invention by receiving from the user all numeric sequences from his database or by express permission of the user the 3rd party accesses and retrieves all numeric sequences from the user database AND it's the 3rd party that performs the automated process of database synchronization in the form of detecting, reporting and if express permission is given by the user process the information associated with any match between any numeric sequence from the user database and the 3rd party database. This ensures thus full confidentiality and data protection, as no information other then numeric sequences are provided by user to 3rd party and its actually the 3rd party who provides information from its database to the requesting user if and only if a match, as described herein in this invention, is found.

The system performed by a 3rd party company, on behalf of a user, will for every numeric sequence (be it a product ID, a phone number or any such other numeric sequence tag) of the user to which it finds a maximum number of digits matched against any available numeric sequence in its database report the data associated with that numeric sequence matched for further processing by the user or in the event of express permission granted by user to 3rd party, than in this last case the 3rd party would as part of this system herein perform the processing of the matched numeric sequence in the user own database by adding any missing data associated to that specific matched numeric sequence in the user own database (i.e. tag the numeric sequence with a product name or as being identified as being also a common 3rd party service user).

An object of the present invention is to reduce the time and effort, but more importantly the probability of error, to synchronize a database from an private individual or business with the database of 3rd party, performed in a fully automated and dynamic manner by the 3rd party with express consent of such private individual or business.

Another object of the present invention is to help private individual or business users to identify the common identities of numeric sequences (product ID or phone numbers or IMSI) between their own database(s) and one or more 3rd party database(s).

Another object of the invention is to help private individuals or business users to identify materials parts, products or parcels in the user's database to be updated with any such up-to-date information of those common identities of numeric sequences (material part ID, product ID or parcel ID) between the user's own database(s) and one or more 3rd party database(s).

Another object of the present invention is to provide a system that maintains the database of a user and a 3rd party database(s) synchronised at future time intervals (as described herein before) for any additional user numeric sequence added in future in the user database by the user OR added in the 3rd party database by a 3rd party user.

Additional features and advantages of the invention will be set forth in the description which follows, and in part will be apparent from the description, or may be learned by practicing the invention. The objectives and other advantages of the invention will be realized and attained by the structure particularly pointed out in the written description and claims as well as the drawings hereto.

### BRIEF DESCRIPTION OF THE DRAWING

FIG. 1 is a schematic diagram of a preferred embodiment of the present invention.

FIG. 2 is a flow diagram of a preferred embodiment of the present invention.

FIG. 3 is a flow diagram of another different preferred embodiment of the present invention.

FIG. 4 is a flow diagram of yet another different preferred embodiment of the present invention.

FIG. 5 is an example of an incoming number in international format being checked against a database International Number.

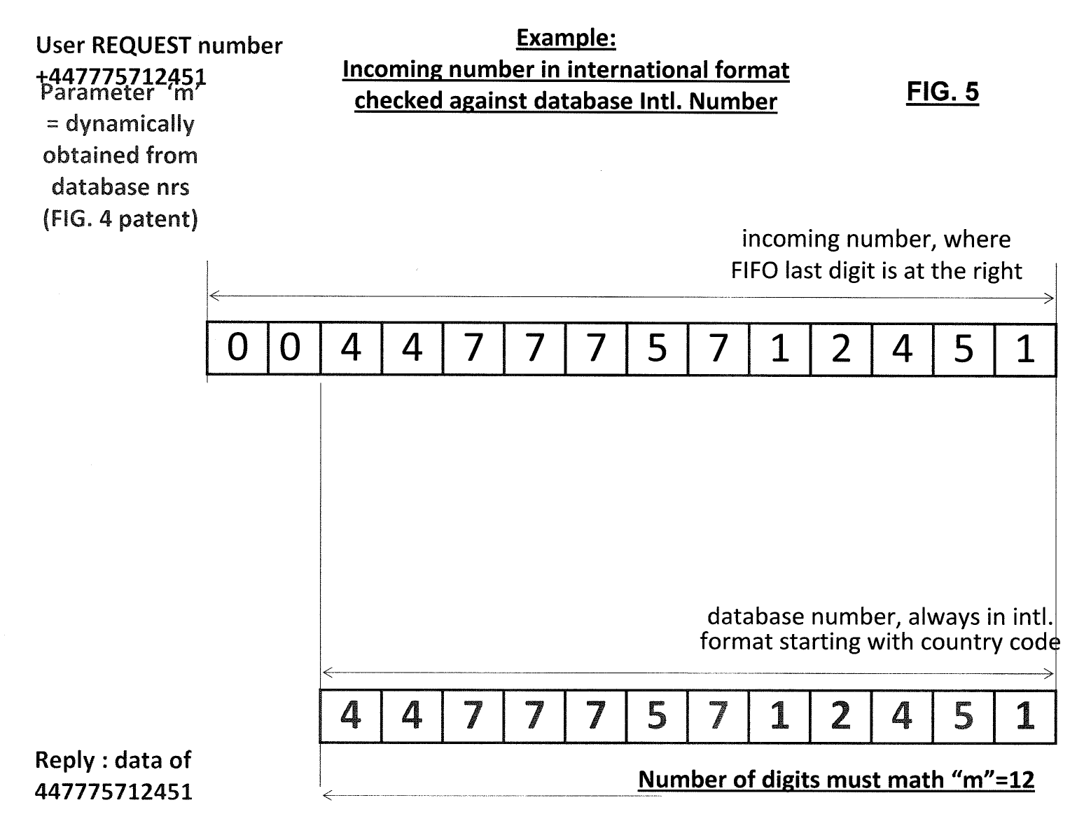

FIG. 6 is an example of an incoming number in local format being checked against a database International Number.

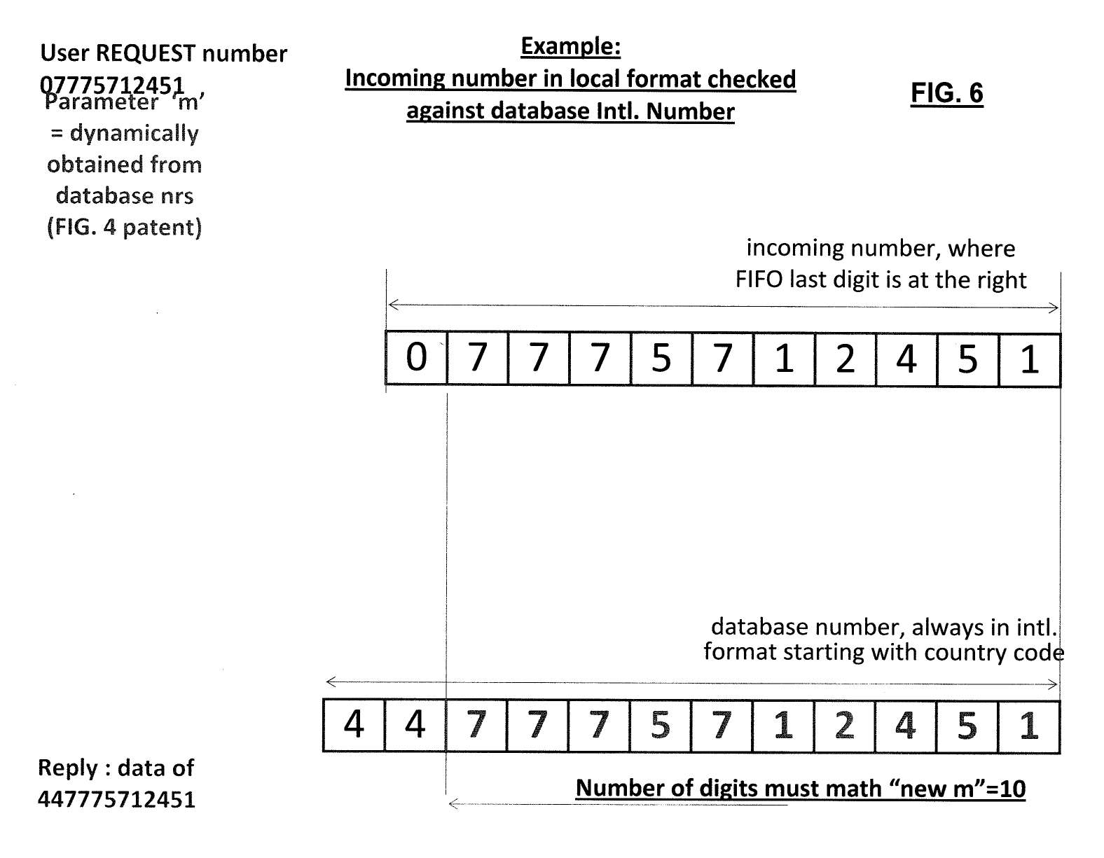

### DETAILED DESCRIPTION OF THE INVENTION

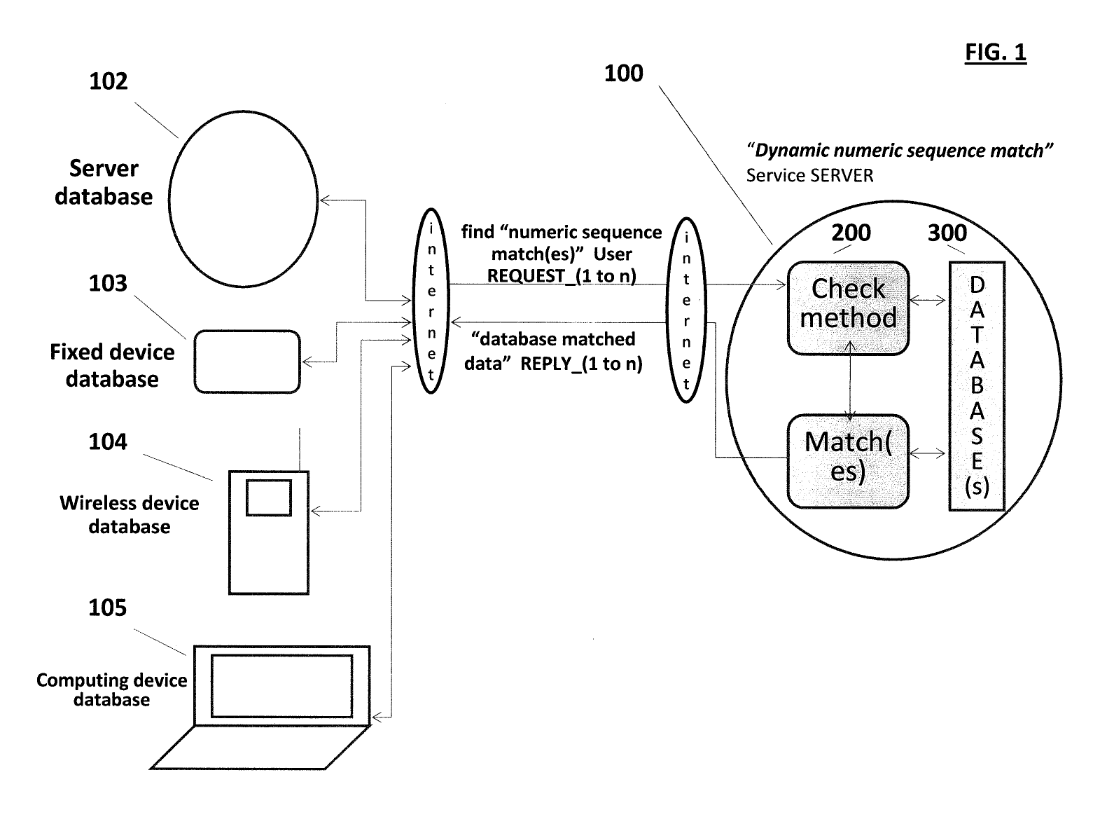

Referring to FIGS. 1, 2 and 3, a system, which could be a private or commercial server 100, in any location in the world which uses internet services, and which includes one or more databases and an external internet access to the system 100. Additional external access means to the system can also be present. Additional external databases may be accessible to the system 100.

To use the “Dynamic numeric sequence match” service, the user must contact the server and subscribe to the service or only in some very specific cases only where the information of a specific database accessible to the system consists explicitly and only of public information without any legal restriction on disclosure of any form from any third party whatsoever, only in this last case potential no subscription would be required if so decided by such 3rd party using this invention.

The system 100 resident in a server preferably keeps a record of the subscribers (with their express consent) and notes their user identification and originating address to reply to. In the example shown in FIG. 1, it is assumed that a subscriber or user has requested several checks to the system in the form of sending to the system a string of 1 to n “numeric sequences”. The system 100 will perform the “Check method” 200 between each “input numeric sequence” and all those available numeric sequences in the database 300 and reply back to the subscriber or user with the corresponding information or data associated with each matched numeric sequence from the database(s) 300. The subscriber or user that would access the “Dynamic numeric sequence match” system (100) over the internet would originate typically from a Computing Device 105 (PC, Tablet or similar devices), Wireless Device 104 (Mobile Phone, Smartphone or similar devices), Fixed Device 103 (data storage units or similar devices) or server databases 102 (databases different to the system databases and resident in a different server then the system server).

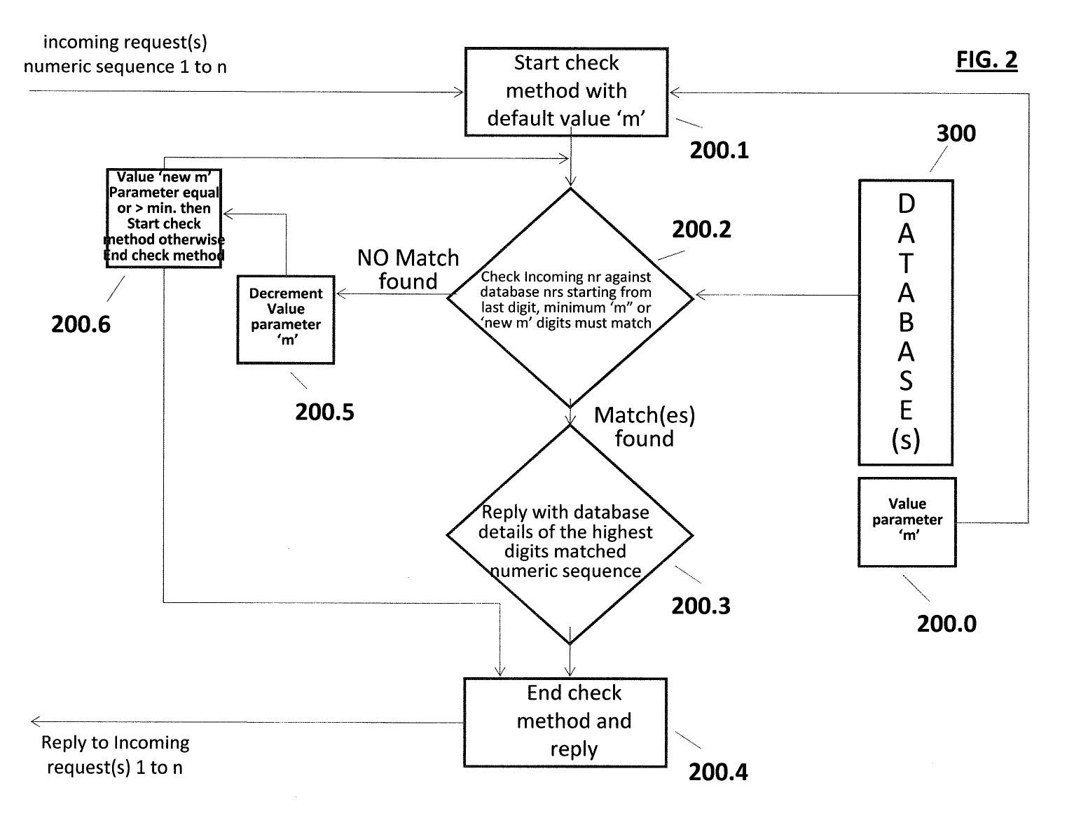

The “check method” 200 of performing the “Dynamic numeric sequence match” of FIG. 1 is detailed in the example shown in FIG. 2, wherein the trigger to start the check method 200.1 is the receipt of a numeric sequence, in example “input request 1” being a number of certain length (for example sake a local format telephone number of 10 digits) and extracting the default “starting threshold of number of digits that must match” defined as parameter “m” (for example sake since no international dialling code nor country present m=10−1=9). Then the method will compare in 200.2 starting from last to first digit, the incoming numeric sequence (local phone number) and compare sequentially against all available individual numeric sequences available in the database 300. If one or more matches is found then the matched data will be passed on by 200.3 corresponding to the highest number of digits matched (in this example 9 or 10 digits match). This match data (i.e. operator or service provider name, contact data or simply match acknowledgement to a given numeric sequence) is then replied back to the requesting party by 200.4.

If however no match is found by 200.2 than previous parameter “m” is decremented by 1 (in this example then m=8) by 200.5 and consequently checked in 200.6 if this new value is equal or more than “minimum preset value” say for this example 4). If it would have been lower than 4 it would have used 4 as the last loop check. In this example the new “m” value is 8 and thus the check method start 200.1 is triggered by 200.6 with the same input numeric sequence and the new parameter “m”=8. If still no match is found by 200.2 this previous loop of decrementing “m” by 1 and re-starting the check method would continue until a match is found or until m=4 (“minimum preset value”), whichever comes first.

This automated dynamic way of searching for matches between an incoming numeric sequence and any available numeric sequence in the database 300 is generally very fast because web access and database access is generally fast compared with the time it takes a subscriber to compare or update manually his database with 3rd party databases 300. Furthermore as the numeric sequences would be stored in the system 100 it would at predetermined future time intervals synchronised with the relevant added or updated information of 3rd party databases (300) and reply those matches back to the corresponding subscriber or user associated to the store input numeric sequences to which in the past no match was found or its data was not up to date.

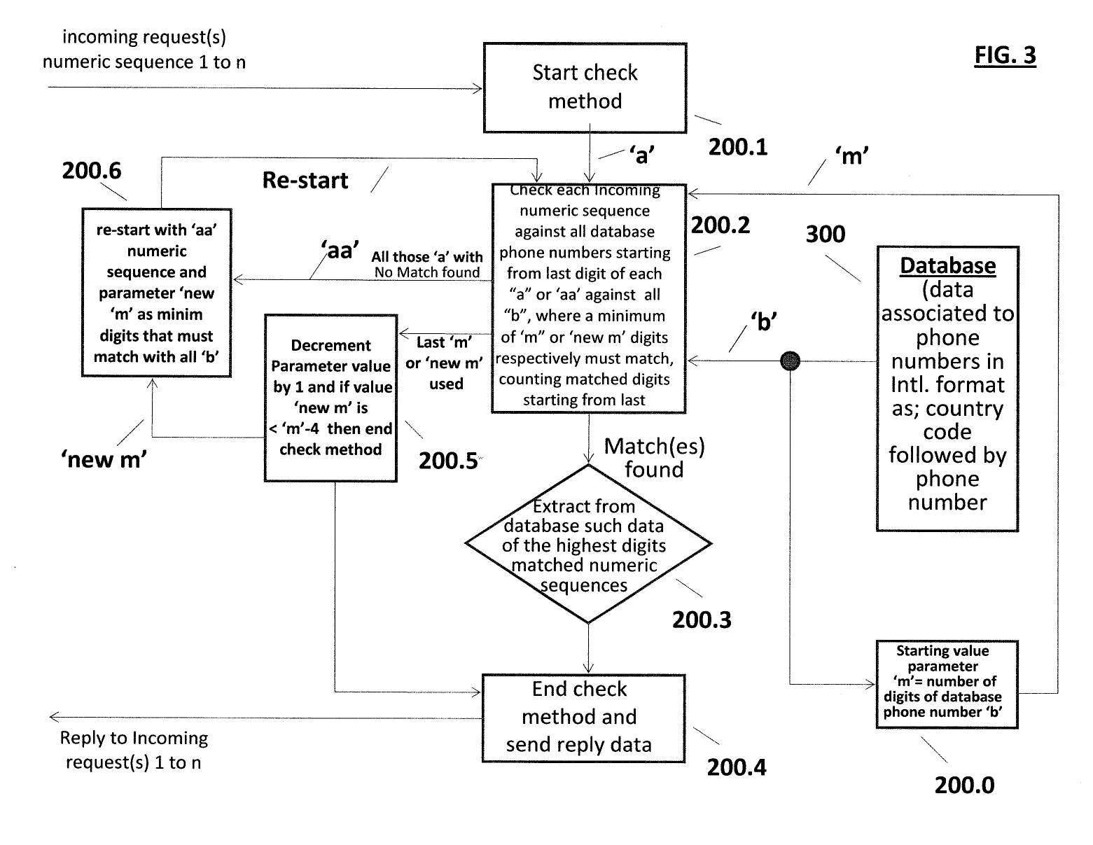

Another preferred embodiment of the current invention, method different than that shown in FIG. 2, is shown in detail in FIG. 3, wherein each input numeric sequence triggers 200.1 to start the match check between “a” (a phone number in any international format or any local format of any region world-wide) and “b” (any different numeric sequence from the accessible database 300). For each individual and consecutive “b” the minimum amount of digits that must match are calculated dynamically. The first used value of digits that must match “m” are calculated for each “b” as “m”=number of digits of “b” and used as minimum number of digits that must match between that specific previous “b” checked against all available “a”. Then as also shown in FIG. 3 all relevant or corresponding data of each “b” where 200.2 detects a match between a given “a” and a specific “b” using “m”, dynamically obtained by 200.0, will be reported as reply by 200.3 to the requesting subscriber or user or to its database through 200.4 who then stops the check for that specific “a” and re-starts check with next “a” or stops check method if no more “a” available. However all those specific “a” that did not match against any “b” are reclassified by 200.2 as “aa” and re-used in 200.6 together with previous used parameter “m” decremented by 1 in 200.5 s the “new m” to re-start the check method 200.2 using as new input numeric sequences all “aa” checked against each “b” with parameter “new m” for each “b” as the new decremented minimum amount of digits that must match between any “aa” and each specific “b” counting from last to first digit. This last step preformed by 200.5 and 200.6 of decrementing the last used “m” or “new m” by 1 and re-starting the check method at 200.2 is performed automatically for all consecutive “aa” (new no matched input sequences) until a match is found or until “new m”=“new m”=(number of digits of “b”−4), whichever comes first and then automatically triggers an end check method at 200.4.

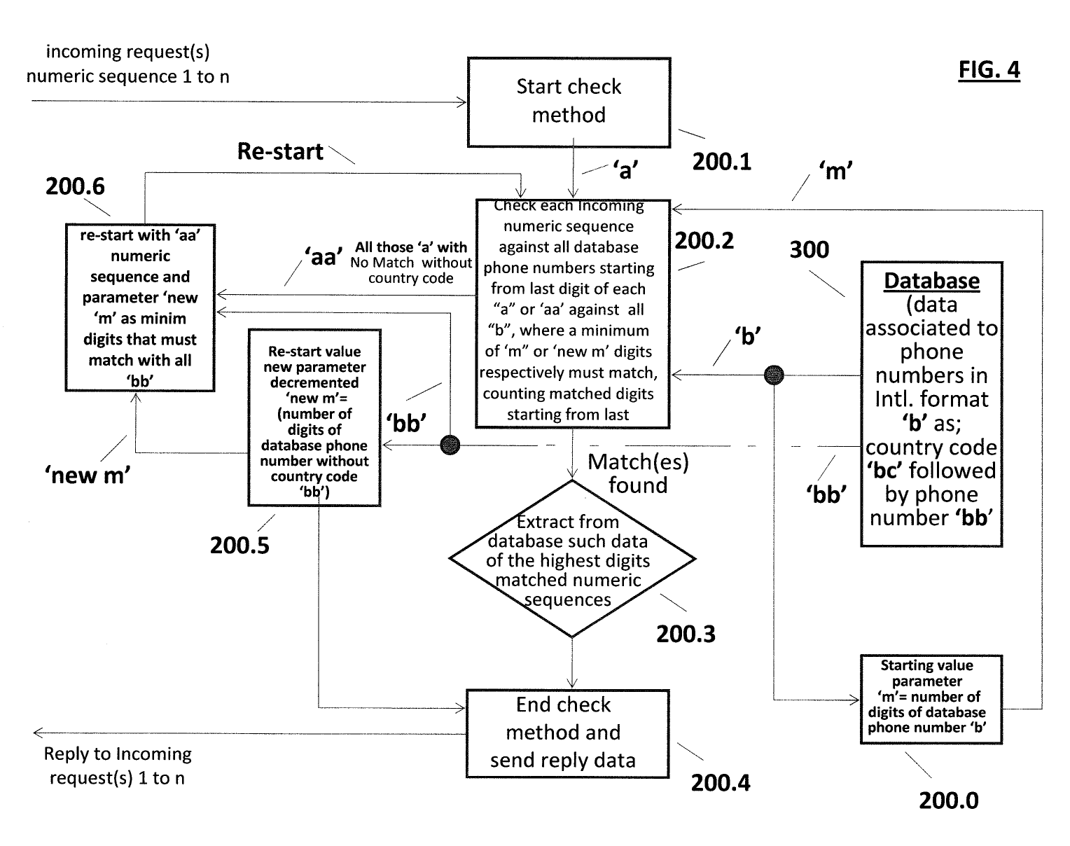

Yet another preferred embodiment of the current invention, method different than that shown in FIG. 2 and FIG. 3, is shown in detail in FIG. 4, wherein each input numeric sequence triggers 200.1 to start the match check between “a” (a phone number in any international format or any local format of any region world-wide) and “b” (any different numeric sequence from the accessible database 300). For each individual and consecutive “b” the minimum amount of digits that must match with a given input “a” are calculated dynamically. The initial or first used value of digits that must match referred to as “m” are calculated by 200.0 for each “b” as follows “m”=number of digits of “b” and used as minimum number of digits that must match between that specific “b” used to calculate previous individual “m” and checked against all available inputs “a”. The initial value “m” may be different for each next different to previous “b” checked against all inputs “a”. Then as also shown in FIG. 4 all relevant or corresponding data of each individual “b” where 200.2 detects a match between a given “a” and such specific “b” using “m”, dynamically obtained by 200.0, will be reported as reply by 200.3 to the requesting subscriber or user or to its database through 200.4 who then stops the check for that specific “a” and re-starts check with next “a” or stops check method if no more “a” available. However all those specific “a” that did not match against any “b” are reclassified by 200.2 and referred to as “aa” and re-used in 200.6 together with a new parameter “new m” calculated dynamically by 200.5 for each “b” as follows “new m”=number of digits of “bb”, where “bb” is the “b” from the database excluding the country code, and used by 200.6 to re-start the check method 200.2 using as new input numeric sequences all “aa” checked against each “bb” with the corresponding parameter “new m” for each “bb” as the new decremented minimum amount of digits that must match between any “aa” and each specific “bb” counting from last to first digit. This last step preformed by 200.5 and 200.6 will be repeated only once for any remaining non matches of remaining “aa” against “bb” with corresponding new parameter decremented by one as “new m” by 200.5 and then by 200.6 re-starting the check method at 200.2 is performed automatically for all consecutive “aa” (remaining no matched input sequences) until a match is found or until “new m”=(number of digits of “bb”−2), whichever comes first and then automatically triggers an end check for that corresponding “bb” against all “a” till no more “bb” to be checked against all “a” and then triggers automatically an end check method at 200.4.

Any of the various components or sub-steps disclosed above can be used either alone, or in multiple parallel set-ups, or with other components, or with components or features of the present invention.

It will be apparent to those skilled in the art that various modifications and variations can be made to the “Dynamic numeric sequence match” system or “Check method” of the present invention without departing from the spirit or scope of the invention.

The foregoing disclosure of embodiments of the present invention has been presented for purposes of illustration and description. It is not exhaustive or intended to limit the invention to the precise forms disclosed herein. Many variations and modifications of the embodiments described herein will be obvious to one of ordinary skill in the art in light of the above disclosure. The scope of the invention is to be defined only by the claims appended hereto, and by their equivalents.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

1. A system for detecting or determining any given “input numeric sequence” potential match against all available “numeric sequences” accessible from any given database comprising: (a) the system adapted to receive an input numeric sequence of any length; (b) the system comprising access to information of one or more databases;
(c) the system capable of extracting and reporting dynamically all associated information from a database associated with a numeric sequence from that database of such database numeric sequence that has the highest match of identical digits with the input numeric sequence.

2. The system of claim 1 capable of in the event no match is found between a given input numeric sequence and any numeric sequence in the accessible databases to reverse the input number sequence (change from first to last towards last to first digit) and use the reverse numeric sequence as the next input numeric sequence.

3. The system according to claim 1, wherein the input numeric sequence and any consecutive input numeric sequence can be of any length and different in length between any consecutive input numeric sequence.

4. The system according to claim 1, wherein the system retrieves all database information associated with the numeric sequence from such database, related to those database numeric sequence which have the highest digits match with each corresponding input numeric sequence and provides that information to the corresponding input numeric sequence destination for further processing or storage.

5. The system according to claim 1, wherein the system has access to the database of the originating destination of the input numeric sequence and processes and stores part or whole of the information corresponding to the match numeric sequence form the database accessible to the system.

6. A method for selecting dynamically the highest probability match between an “input numeric sequence” and any “accessible database numeric sequence” comprising the steps of: (a) buffering all received “input numeric sequence(s)” and trigger a start of the “check method” on a first come first served basis upon receipt of any input numeric sequence or “incoming check request”; (b) comparing an “incoming numeric sequence” to any and each numeric sequence in the accessible databases, starting comparing digit by digit from last to first with a minimum required “starting threshold of number of digits that must match” counted from last to first; (c) if a match is found stop check method and report all information from database associated to the matched numeric sequence and re-start the check method with the next incoming numeric sequence or if no more input numeric sequence available stop check method till receipt of next incoming check request. However if no match is found then “decrement the starting threshold of number of digits that must match” and restart the check method only for the input numeric sequences that did not match using the new decremented parameter as starting threshold and repeat this decrement loop until a match is found or until the “decremented starting threshold of number of digits that must match” has reached the “minimum preset value”, whichever comes first and then re-start the check method with the next incoming numeric sequence or if no more input numeric sequence available stop check method till receipt of next incoming check request.

7. The method according to claim 6, wherein the “starting threshold of number of digits that must match” and “minimum preset value” is user programmable.

8. The method according to claim 6, wherein “starting threshold of number of digits that must match” and “minimum preset value” are dynamically obtained automatically by the system itself in the event the input numeric sequence(s) is a phone number (in an international format or a local format of any region) and the database(s) contains numeric sequences of phone numbers in the international format (country code followed by phone number) as follows;
“starting threshold of number of digits that must match”=(number of digits corresponding to numeric sequence from the database used); and such parameter may be different when matching an input numeric sequence against each next different numeric sequence from the database, but for those input numeric sequences that have no match against any numeric sequence of the database than those non matched input sequences will be re-checked with decrementing previously calculated “starting threshold of number of digits that must match” by 1 or if still no match keep decrementing until a match is found or until “last used starting threshold of number of digits that must match”=“minimum preset value” then stop check method, whichever comes first.
“minimum preset value” when checking against each numeric sequence from the database=number of digits corresponding to each such numeric sequence from the database−country code digits; and if country code digits are unknown in the database then “minimum preset value”=number of digits corresponding to each such numeric sequence from the database−4; this “minimum preset value” may be different when matching an input numeric sequence against each next different numeric sequence from the database.

9. The method according to claim 6, wherein “starting threshold of number of digits that must match” and “minimum preset value” are dynamically obtained in the event the input numeric number is a phone number as follows;
“starting threshold of number of digits that must match”=(number of digits of input numeric sequence) - (number of digits of the international dialling code and country code), but if no international dialling code or country code is present in the input numeric number then subtract one.
“minimum preset value””=amount of digits of emergency numbering+one.

10. The method according to claim 6, further comprising the step of storing incoming check requests and the corresponding input numeric sequence(s) information to perform the check method immediately or at preselected intervals or re-start the check method at regular future intervals only for those input numeric sequences that did not match against any numeric sequences from the accessible databases to the system.

11. The method according to claim 6, further comprising the step of storing all the information from the database that relates or associated to any numeric sequence from the database which corresponds to a match with any incoming numeric sequence request, such output information to be provided to the destination of the incoming numeric request immediately or at preselected intervals.

12. The method according to claim 6, wherein the database maintains information associated with input numeric sequence requests.

13. The method according to claim 6, wherein the “input numeric sequence”(s) can be identification numbers or tracking number of a material part or parcel of any length.

14. The method according to claim 6, wherein the “input numeric sequence”(s) can be telephone numbers in any local or international format of any length.

15. The method according to claim 6, wherein the “input numeric sequence”(s) can be IMSI (International Mobile Subscriber Identity) of any length.

16. The method according to claim 6, where the method output numeric matches are used to synchronize the database wherefrom the “input numeric sequence”(s) originated from with the data extracted from the corresponding matched numeric sequence data from the searched database.

17. The method according to claim 1, wherein the “input numeric sequence”(s) can be identification numbers or tracking number of a material part or parcel of any length.

18. The system according to claim 1, wherein the “input numeric sequence”(s) can be telephone numbers in any local or international format of any length.

19. The system according to claim 1, wherein the “input numeric sequence”(s) can be IMSI (International Mobile Subscriber Identity) of any length.

20. The system according to claim 1, where the system output numeric matches are used to synchronize the database wherefrom the “input numeric sequence”(s) originated from with the data extracted from the corresponding matched numeric sequence data from the searched database.
